(19) United States
(12) Patent Application Publication
(10) Pub. No.: US 2003/0080958 A1
(43) Pub. Date: May 1, 2003

(54) Image generating apparatus, image generating method, and computer program

(76) Inventors: Reiji Matsumoto, Tsurugashima-shi (JP); Hajime Adachi, Tsurugashima-shi (JP)

Correspondence Address: YOUNG & THOMPSON, 745 SOUTH 23RD STREET 2ND FLOOR, ARLINGTON, VA, 22202

(21) Appl. No.: 10/254,928

(22) Filed: Sep. 26, 2002

(30) Foreign Application Priority Data
Sep. 26, 2001 (JP) 2001-295167

(51) Int. Cl. G06T 15/40

(52) U.S. Cl. 345/421

(57) ABSTRACT

An image generating apparatus (1) is provided with a graphics memory (16) and a drawing device (13). The graphics memory includes a plurality of frame buffers (16a,16b) for separately storing images of a plurality of layers containing a 3D image and one Z-buffer (16c) commonly installed for these frame buffers. The drawing device sequentially stores the images of the plurality of layers in the plurality of frame buffers as well as sequentially generating them while executing a hidden surface removal by using the Z-buffer in time sharing, superimposes at a superimposing unit (17) the images of the plurality of layers, which are stored in the plurality of frame buffers, after the execution of the hidden surface removal, and consequently generates a multiple-layer 3D image.

### BACKGROUND OF THE INVENTION

1. Field of the Invention

The present invention relates to an image generating apparatus for and an image generating method of generating a three-dimensional (3D) image on the basis of three-dimensional coordinate information, which is applied to a navigation system or the like, and a computer program to perform the image generating method. More particularly, the present invention relates to an image generating apparatus and an image generating method, which enable to display a multiple-layer 3D image generated by superimposing images of a plurality of layers containing a 3D image, and a computer program to perform such an image generating method.

2. Description of the Related Art

Recently, the research development of an electronic control for controlling a drive of a car and the spread of a navigation system for supporting a drive are remarkable. In general, the navigation system is basically designed so as to have various databases and to display map information, current position information, various guidance information, etc. on a display unit. Moreover, such a navigation system is typically designed so as to search for a drive route in accordance with an input condition. Then, it is designed so as to display the searched drive route and a current position based on a GPS (Global Positioning System) measurement or a self-contained measurement on a map and carry out guidance (navigation) to a destination. Moreover, in some types of navigation systems, a view on a front side from a currently driving point in addition to the drive route is displayed on a display unit. In addition, an indication of a driving lane, a direction to be curved at a crossing, a distance to a crossing, a distance to a destination, an arrival expectation time and the like are displayed. In such navigation systems, the forward view is displayed as a three-dimensional image in perspective, which is a technique for drawing a three-dimensional image on a plane on the basis of view point of a viewer. Hereinafter, such a three-dimensional image is referred to as a 3D image.

As a technique for displaying a 3D image or the like, there is a Z buffer algorithm using a hidden surface removal. In some navigation systems, the Z-buffer algorithm is used as a part of a drawing engine in order to display a 3D image. In the drawing engine using the Z-buffer algorithm, a drawing space is divided a plurality of drawing portions, and the image part located closest to a viewer among image components including a plurality of partial frames constituting one frame (for example, an image of a road, an image of one building, an image of a different building, an image of a sky and the like constituting an image of one frame representative of one view) is stored for each drawing position. Then, the stored image parts of all drawing positions are combined and displayed. Thus, a 3D image of one frame can be finally displayed. Also, if the hidden surface removal using the Z-buffer algorithm is used, it is possible to draw the 3D image, in which not only the view image, but also a plurality of texts, marks, patterns, designs, sketches, backgrounds and the like are cubically superimposed, and the like.

On the other hand, there is a technique for displaying a combined image in which images of a plurality of layers whose kinds are different from each other are superimposed within the same screen. In this specification, such a combined image is referred to as a multi-layer image. For example, in a car navigation apparatus, a technique for displaying a multi-layer image is put to practical use. According to this technique, various image information, such as related text information, various icons and marks, map information of different scale, etc. are superimposed on basic map information. In this technique, a plurality of frame buffers are prepared correspondingly to the number of the layers. The images of the layers are stored in the frame buffers, respectively. By superimposing the images stored in the respective frame buffers, the multi-layer image can be displayed.

If technique of the hidden surface removal using the Z-buffer algorithm and the technique for displaying a multi-layer image are combined, it is possible to display a complex, real and high quality image by superimposing the images of the plurality of layers containing the 3D image. Hereinafter, such a combined 3D image is referred to as multiple-layer 3D image.

By the way, in various electronic apparatuses including a car navigation apparatus and the like, from the view point of the saving of hardware resource or the cost-cutting or the like, there is a typical request of a reduction in a memory capacity.

However, in order to display the multiple-layer 3D image or the like, the hidden surface removal using the Z-buffer algorithm is carried out for the respective layers. In order to carry out the hidden surface removal using the Z-buffer algorithm for the image of single layer, a pair of a frame buffer and a Z-buffer is needed. Therefore, in the case of the multiple-layer 3D image, a pair of a frame buffer and a Z-buffer is needed for each layer of the multiple-layer image. That is, the frame buffers whose number is equal to the number of the total layers of the multiple-layer image and the Z-buffers whose number is equal to the number of the total layers of the multiple-layer image are needed, which results in a problem that the entirely necessary memory capacity becomes enormous.

For example, according to Direct3D of Microsoft Corporation, with regard to the graphics library for the 3D image using the Z-buffer, a frame buffer and a Z-buffer is one to one correspondence. Thus, in order to draw the 3D image for a plurality of layers, it is necessary to reserve the Z-buffers whose number is equal to the number of the total layers. On the other hand, according to OpenGL that is API (Application Programming Interface) of Silicon Graphic Corporation, the graphics library for the 3D image using the Z-buffer is configured under the concept of a single layer. Therefore, it is difficult to apply this graphics library to the multiple-layer 3D image.

### SUMMARY OF THE INVENTION

It is therefore an object of the present invention to provide an image generating apparatus and an image generating method that can display a multiple-layer image, a multiple-layer 3D image and the like, while relatively reducing an entirely necessary memory capacity, and to provide a computer program to perform the image generating method.

The above object of the present invention can be achieved by an image generating apparatus provided with: an image generating device for generating images of a plurality of layers containing a three-dimensional image; an image storing device comprising a plurality of frame buffers for separately storing the generated images of the plurality of layers and one Z-buffer; a processing device for carrying out an image processing including a hidden surface removal on the generated images of the plurality of layers by using the Z-buffer in a time sharing manner; and a superimposing device for superimposing the images on which the image processing is carried out by the processing device.

According to the image generating apparatus of the present invention, the image generating device generates images of the plurality of layers containing a three-dimensional image(s) (i.e. a 3D image(s)). The generated images are separately stored in the frame buffers. For example, the plurality of frame buffer are prepared correspondingly to the respective layers. In this case, the generated images are separately stored in the corresponding frame buffers, respectively. Then, the processing device carries out the image processing including the hidden surface removal on the generated images of the plurality of layers. At this time, the processing device uses the single Z-buffer in the time sharing manner. Namely, the processing device carries out the hidden surface removal on the respective images of the plurality of layers at different times, for example, in a sequential manner. Then, the images on which the image processing including the hidden surface removal is carried out by the processing device are stored in, for example, the frame buffer corresponding to the plurality of layers. Thereafter, the superimposing device superimposes the images. Thus, the multiple-layers 3D image can be generated. Especially, the image storing device has one Z-buffer, and the processing device carries out the image process including the hidden surface removal on the images of the plurality of layers by using the one Z-buffer. Therefore, it is possible to extremely reduce a memory capacity, compared to the case of having the Z-buffer individually for each of the images of the plurality of layers.

As a result, the image generating apparatus of the present invention is preferable for the application that it is extremely important in practice to reduce the memory capacity for graphics of, for example, a car navigation system and the like.

In one aspect of the image generating apparatus of the present invention, the image generating apparatus is further provided with a clearing device for clearing the Z-buffer whenever completing the image processing of each one of the images of the plurality of layers.

According to this aspect, since the Z-buffer is cleared whenever completing the image process including the hidden surface removal of each one of the images of the plurality of layers, it is possible to carry out the hidden surface removal for each image by using the one Z-buffer in the time sharing manner.

In another aspect of the image generating apparatus of the present invention, the images of the plurality of layers contain a three-dimensional image which is to be drawn in perspective.

According to this aspect, such a view that a driver can see from a driver's seat is displayed as the three-dimensional image with perspective, which allows the driver to easily recognize the image by corresponding it to the actual view.

In another aspect of the image generating apparatus of the present invention, the image generating apparatus further provide with: a drawing object information generating device for generating drawing object information, which is information for drawing objects as the three-dimensional image, in a single coordinate system; a coordinate transformation information generating device for generating coordinate transformation information, which is information for defining at least one of a view point and a field of view concerning the three-dimensional image; a drawing object information storing device for storing the drawing object information; and a coordinate transformation information storing device for storing the coordinate transformation information. In this construction, the image generating device generates the three-dimensional image by using the stored drawing object information and the stored coordinate transformation information.

According to this aspect, when the three-dimensional image contained in the images of the plurality of layers is created and displayed, the drawing object information and the coordinate transformation information concerning the objects to be drawn as the three-dimensional image are separately generated by the independent devices, i.e. the drawing object information generating device and the coordinate transformation information generating device. Furthermore, the drawing object information and the coordinate transformation information are separately stored and managed by the independent devices, i.e. the drawing information storing device and the coordinate transformation information storing device. Then, the three-dimensional image is generated by the image generating device on the basis of the drawing object information and the coordinate transformation information. Thereafter, the generated three-dimensional image is displayed with, for example, a display device. Thus, the drawing object information and the coordinate transformation information are separately and independently prepared and the process of generating the three-dimensional image on the basis of these information is carried out all at once. Consequently, it is possible to improve a processing speed (i.e. a drawing speed) of the creation of the image.

Furthermore, as the processing speed can be made higher when generating the three-dimensional image of one or each layer, the three-dimensional image can be created like a burst processing manner. Therefore, it takes only an extremely short time to execute the hidden surface removal by using the Z-buffer when generating the three-dimensional image of one or each layer. Consequently, it becomes easy to execute the hidden surface removal on the images of the plurality of layers by using the one Z-buffer in the time sharing manner.

Incidentally, in this aspect, the drawing object information generating device may be constructed so as to generate the drawing object information in such a way that the drawing object information is divided into predetermined information units. For example, the predetermined information unit is defined on the basis of the unit of a display list. If the drawing object information is generated for each unit of the display list, the unit of the drawing object information matches the unit of the process of generating the three-dimensional image by using the drawing object information and the coordinate transformation information in the image generating device. In addition, within the same predetermined information unit of the same display list or the like, the coordinate system is unified; however, it is not necessary to unify the coordinate system between the different predetermined information units.

In another aspect of the image generating apparatus of the present invention, the coordinate transformation information generating device generates a plurality of units of the coordinate transformation information, in which at least one of the view point and the field of view is different from each other, with respect to one unit of the drawing object information, and the image processing device generates the three-dimensional image which changes with time by applying the plurality of units of the coordinate transformation information to the one unit of the drawing object information.

According to this aspect, when generating the three-dimensional image which changes as time elapses, the coordinate transformation information is changed in the state that the drawing object information is fixed. Therefore, the processing load for drawing can be reduced and the three-dimensional images, which sequentially change, can be quickly created and displayed. For example, it is possible to create the three-dimensional image that sequentially changes according to a traveling of a movable body by sequentially changing the view point of the coordinate transformation information with respect to the same drawing object information. Also, if information defining a light source is included in the coordinate transformation information, it is possible to create the three-dimensional image that sequentially changes as time elapses by sequentially changing the light source of the coordinate transformation information.

In another aspect of the image generating apparatus of the present invention, a process of generating the drawing object information in the drawing object information generating device, a process of generating the coordinate transformation information in the coordinate transformation information generating device, a process of storing the drawing object information in the drawing object information storing device and a process of storing the coordinate transformation information in the coordinate transformation information storing device are carried out with multitasking.

According to this aspect, the drawing object information and the coordinate transformation information are generated and stored by multitasking, so that it becomes possible to prepare the three-dimensional image more quickly as a whole.

In another aspect of the image generating apparatus of the present invention, the drawing object information storing device stores a plurality of units of the drawing object information generated by the drawing object information generating device, the coordinate transformation information storing device stores a plurality of units of the coordinate transformation information generated by the coordinate transformation information generating device, and the image generating device generates the three-dimensional image with an arbitrary combination of one or more than one of the plurality of units of the drawing object information and one or more than one of the plurality of units of the coordinate transformation information.

By constituting in this manner, it is possible to create various three-dimensional images quickly according to use's requirements.

In another aspect of the image generating apparatus of the present invention, the drawing object information generating device is provided with a list generating device for generating a list of the drawing object information.

According to this aspect, the image generating device generates the three-dimensional image by using the list of the drawing object information together with the coordinate transformation information. If the list is generated so as to match the so-called display list, it becomes easy to generate the three-dimensional image with the image generating device.

In another aspect of the image generating apparatus of the present invention, the image generating apparatus includes a drawing application processor and a graphics library. The graphics library is provided with: the drawing object information storing device; the coordinate transformation information storing device; a first controlling device for controlling the image storing device; and a second controlling device for controlling the image generating device and the processing device. The drawing application processor is provided with: the drawing object information generating device; the coordinate transformation information generating device; a first instructing device for instructing the first controlling device to clear the Z-buffer; and a second instructing device for instructing the second controlling device to execute the generation of the three-dimensional image, a generation of other images of the plurality of layers and the image processing.

According to this aspect, it is possible to create the multiple-layer 3D image easily by using the single Z-buffer in time sharing.

In another aspect on the image generating apparatus of the present invention, the image generating device is further provided with a map information supplying device for supplying map information, which contains a source of the drawing object information, to the drawing object information generating device.

According to this aspect, a source of the drawing object information contained in the map information is supplied to the drawing object information generating device. Then, the drawing object information generating device generates the drawing object information on the basis of the source of the drawing object information contained in the map information. If the source of the drawing object information for creating the three-dimensional information is contained in the map information, this source is supplied to the drawing object information generating device. Therefore, the drawing object information generating device can generate the drawing object information for creating the three-dimensional information on the basis of the supplied source. Moreover, for example, when position information of a movable body is obtained from a GPS measurement apparatus or the like, or when route information is inputted by the operator, the coordinate transformation is carried out on the drawing object information by applying the position information or the route information. Thus, the three-dimensional image is created. Then, the three-dimensional image is displayed together with a map image in an overlapping manner. In addition, guidance information without the coordinate transformation can be displayed together with the three-dimensional image and the map image in the overlapping manner. By displaying of the images in the overlapping manner, an operator can easily understand the current position, a route to a destination or the like.

In another aspect of the image generating apparatus of the present invention, the coordinate transformation information includes information for defining a light source.

According to this aspect, it is possible to create the images with a shadow or a shade by using the information of the light source, so that the images can be created more real. Moreover, even if the image generating device or the processing device is substituted, the coordinate transformation information, such as the view point information, the view field information, the light source information, and the like, can be used without change, and it can ensure the real image in the same manner as described above while ensuring its portability.

In another aspect of the image generating device of the present invention, the information for defining the view point is set on the basis of a view point of a movable body operator.

According to this aspect, with respect to at least one layer of the multiple-layer 3D image, such a view that can be seen with the view point of the operator is displayed as the three-dimensional image, which allows the operator to easily recognize it as the image in three dimensions corresponding to the actual view. The view point may be set automatically or manually.

In another aspect of the image generating apparatus of the present invention, the information for defining the field of view is set on the basis of a field of view of a movable body operator.

According to this aspect, with respect to at least one layer of the multiple-layer 3D image, such a view in the field of view of the operator is displayed as the three-dimensional image. The field of view may be set automatically or manually.

In another aspect of the image generating apparatus of the present invention, the image generating apparatus is further provided with a display device for displaying the images superimposed by the superimposing device.

According to this aspect, it is possible to realize various electronic equipment such as a navigation system, such as an on-vehicle navigation system capable of displaying the multiple-layer 3D image or the like; a game apparatus, such as an arcade game, a television game, or the like; a computer, such as a personal computer capable of displaying the multiple-layer 3D image or the like; and so on.

The above object of the present invention can be achieved by a program storage device readable by a computer for tangibly embodying a program of instructions executable by the computer to perform an image generating method. The image generating method is provided with: an image generating process of generating images of a plurality of layers containing a three-dimensional image; a hidden surface removal process of carrying out an image processing including a hidden surface removal on the generated images of the plurality of layers by using one Z-buffer in a time sharing manner; and a superimposing device for superimposing the images on which the image processing is carried out.

According to the program storage device, the integrated control of the above described image generating apparatus of the present invention can be relatively easily realized as a computer reads and executes the program of instructions from the program storage device such as a CD-ROM (Compact Disc—Read Only Memory), a DVD-ROM (DVD Read Only Memory), a hard disc or the like, or as it executes the program of instructions after downloading the program through communication device.

The above object of the present invention can be achieved by a computer data signal embodied in a carrier wave and representing a series of instructions which cause a computer to perform an image generating method. The image generating method is provided with; an image generating process of generating images of a plurality of layers containing a three-dimensional image; a hidden surface removal process of carrying out an image processing including a hidden surface removal on the generated images of the plurality of layers by using one Z-buffer in a time sharing manner; and a superimposing device for superimposing the images on which the image processing is carried out.

According to the computer data signal embodied in the carrier wave of the present invention, as the computer downloads the program in the computer data signal through a computer network or the like, and executes this program, it is possible to realize the integrated control of the above described image generating apparatus of the present invention.

The above object of the present invention can be achieved by an image generating method provided with: an image generating process of generating images of a plurality of layers containing a three-dimensional image; a hidden surface removal process of carrying out an image processing including a hidden surface removal on the generated images of the plurality of layers by using one Z-buffer in a time sharing manner; and a superimposing device for superimposing the images on which the image processing is carried out.

According to the image generating method of the present invention, the hidden surface removal is carried out on the images of the plurality of layers by using the single Z-buffer in the time sharing manner. Therefore, it is possible to extremely reduce a memory capacity, compared to the case of having the Z-buffer individually for each of the images of the plurality of layers.

In one aspect of the image generating method of the present invention, the Z-buffer is cleared whenever completing the image processing of each one of the images of the plurality of layers.

According to this aspect, since the Z-buffer is cleared whenever completing the image process including the hidden surface removal of each one of the images of the plurality of layers, it is possible to carry out the hidden surface removal for each image by using the one Z-buffer in the time sharing manner.

In another aspect of the image generating method of the present invention, the image generating method is further provided with: a drawing object information generating process of generating drawing object information, which is information for drawing objects as the three-dimensional image, in a single coordinate system; a coordinate transformation information generating process of generating coordinate transformation information, which is information for defining at least one of a view point and a field of view concerning the three-dimensional image; a drawing object information storing process of storing the drawing object information; and a coordinate transformation information storing process of storing the coordinate transformation information, wherein, in the image generating process, the three-dimensional image is generated by using the stored drawing object information and the stored coordinate transformation information.

According to this aspect, when the three-dimensional image contained in the images of the plurality of layers is displayed, the drawing object information and the coordinate transformation information concerning the objects to be drawn as the three-dimensional image are separately generated. Furthermore, the drawing object information and the coordinate transformation information are separately stored and managed. Then, the three-dimensional image is generated by using the drawing object information and the coordinate transformation information. Thus, the drawing object information and the coordinate transformation information are separately and independently prepared and the process of generating the three-dimensional image on the basis of these information is carried out all at once. Consequently, it is possible to improve a processing speed (i.e. a drawing speed) of generating of the images.

Furthermore, as the processing speed can be made higher when generating the three-dimensional image of one or each layer, the three-dimensional image can be created like a burst processing manner. Therefore, it takes only an extremely short time to execute the hidden surface removal by using the Z-buffer when drawing the three-dimensional image of one or each layer. Consequently, it becomes easy to execute the hidden surface removal on the images of the plurality of layers by using the one Z-buffer in the time sharing manner.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG.1 is a block diagram showing a basic configuration of an image generating apparatus, which is a first embodiment of the present invention;

FIG.2 is a view illustrating an inner configuration of a graphics library of an image generating apparatus;

FIG.3 is a view illustrating a management of a scene object of an image generating apparatus;

FIG.4 is a flowchart showing a flow of an operation of a graphics library;

FIG.5 is a flowchart showing a flow of an operation of a drawing device of an image generating apparatus;

FIG.6 is a flowchart showing a flow of an operation of a drawing application processor;

FIG.7 is a sequence chart showing an operation of an image generating apparatus;

FIG.8 is a view showing an example of a drawing; and

FIG.9 is a view showing a configuration of a navigation system applied to an image generating apparatus of the present invention as a second embodiment.

### DETAILED DESCRIPTION OF THE PREFERRED EMBODIMENT

The preferred embodiments according to an image generating apparatus and an image generating method and a computer program in the present invention will be explained below with reference to the drawings. By the way, the respective embodiments described below are established as the apparatus in which the image generating apparatus of the present invention is used as a navigation system for a car. However, they are not limited to it. The present invention can be preferably applied to an image generation using a personal computer, an image generation for a television game and the like.

First Embodiment

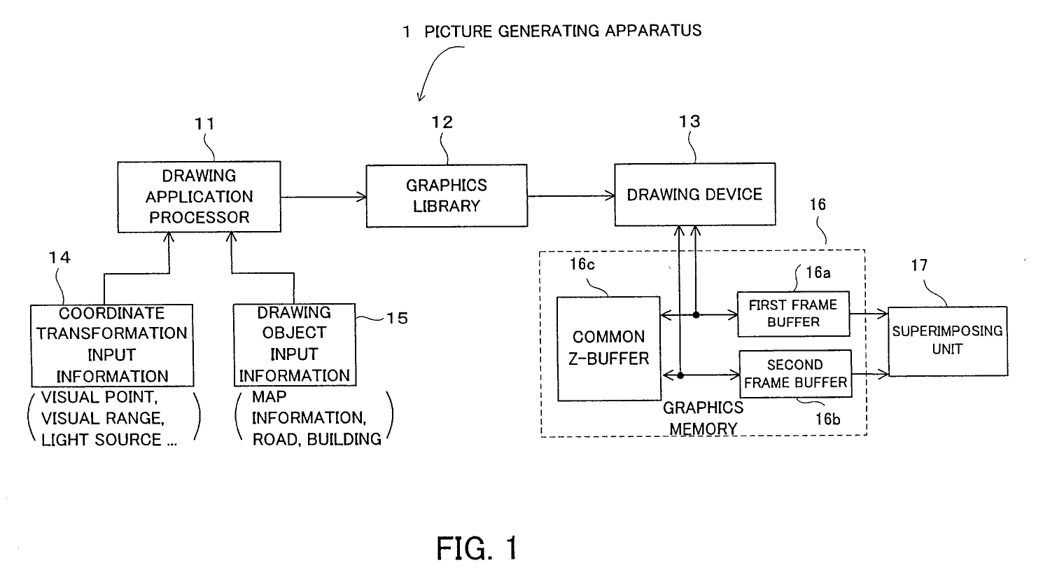

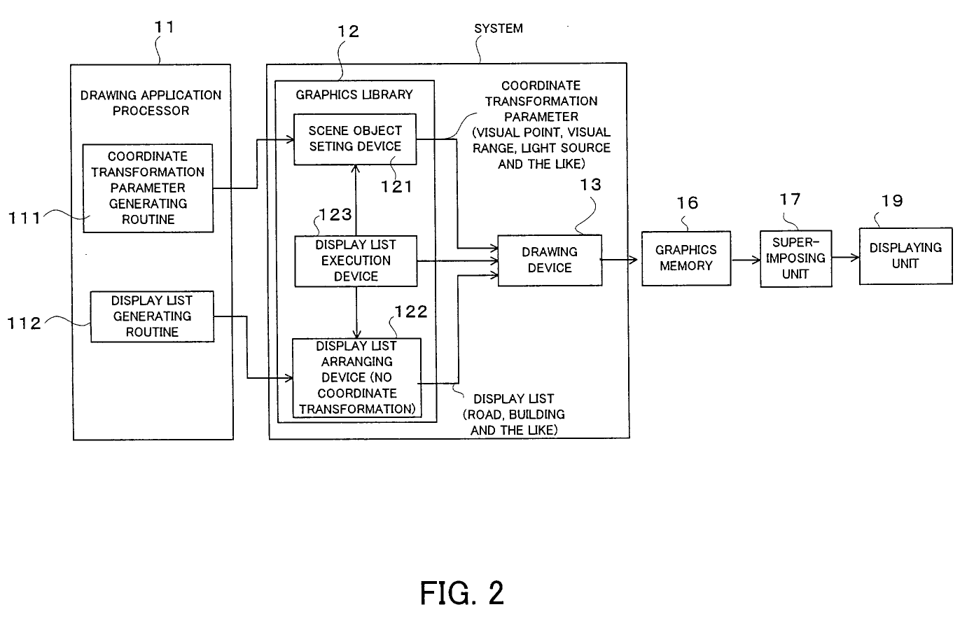

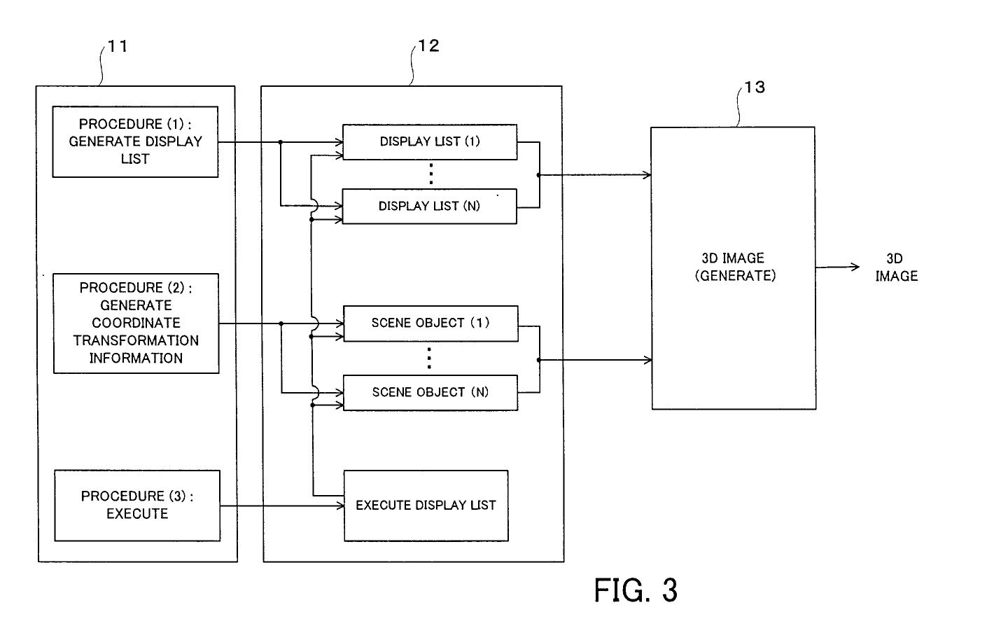

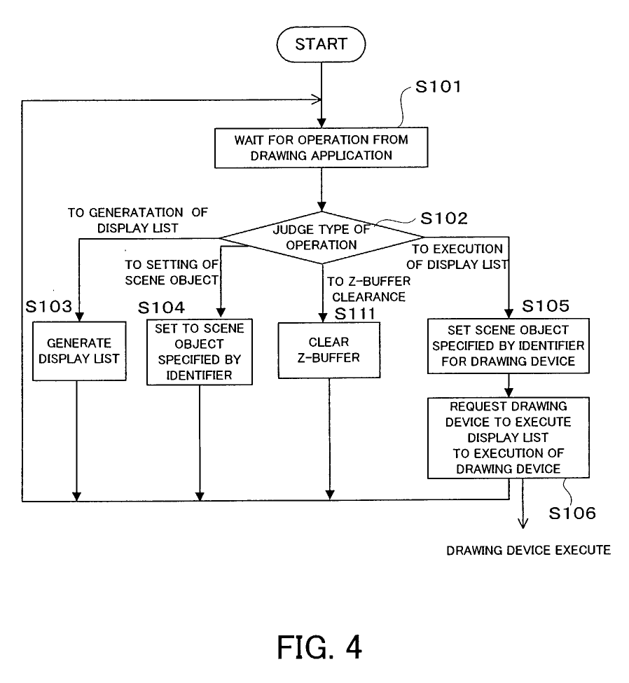

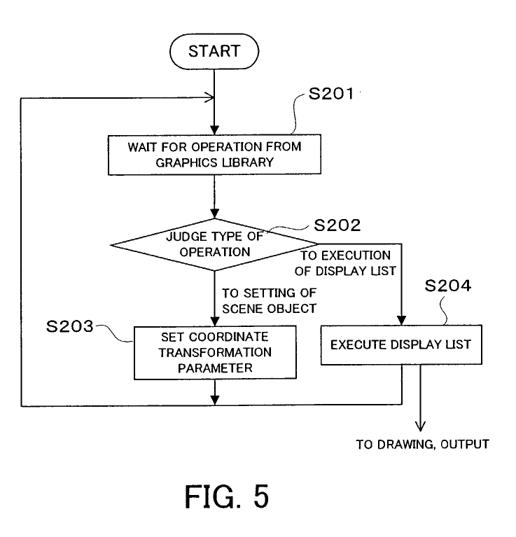

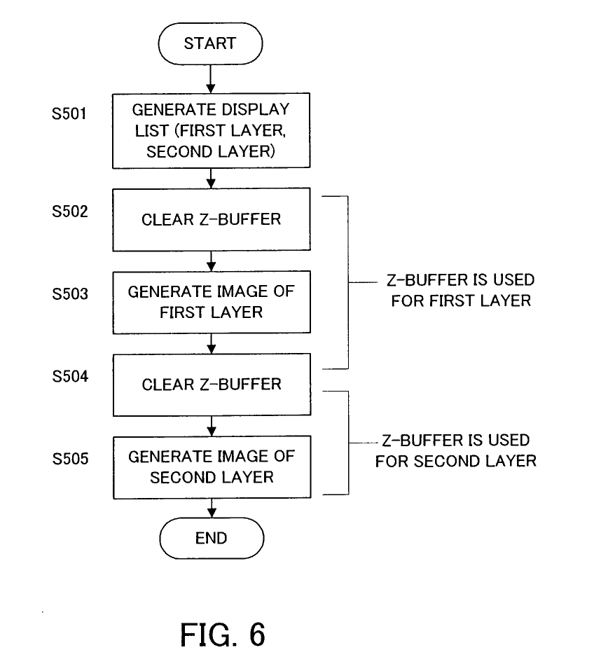

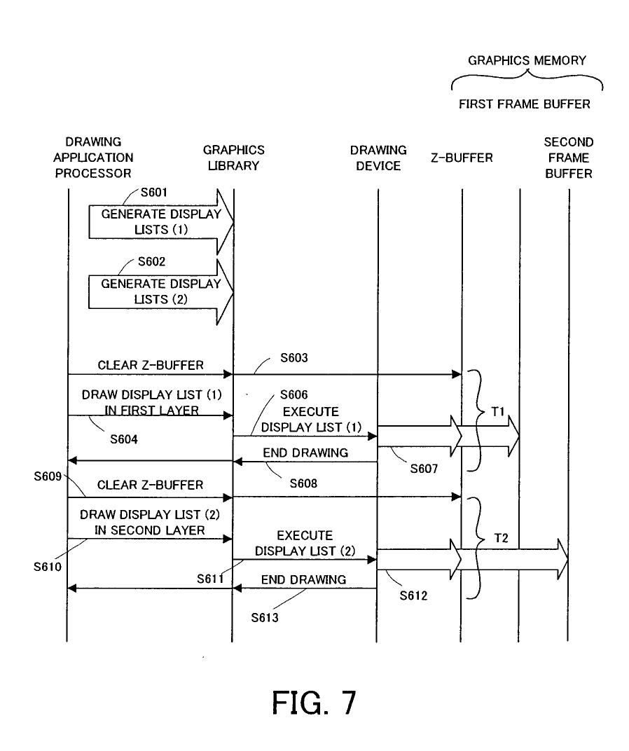

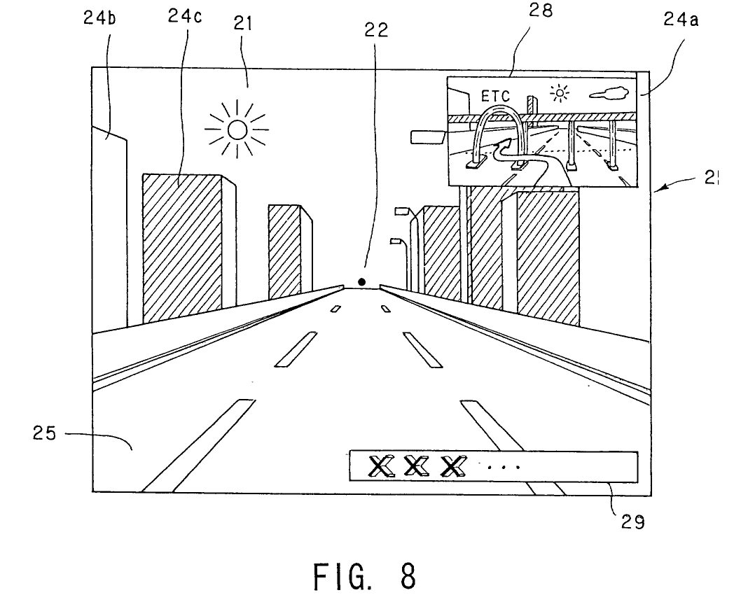

An image generating apparatus in the first embodiment will be described below with reference to FIG. 1 to FIG. 8. Here, FIG. 1 is a block diagram showing a basic configuration of an image generating apparatus, which is a first embodiment of the present invention, FIG. 2 is a view illustrating an inner configuration of a graphics library constituting the image generating apparatus, FIG. 3 is a view illustrating a management of a scene object with regard to an image generating process, FIG. 4 is a flowchart showing a flow of an operation of a graphics library constituting the image generating apparatus, FIG. 5 is a flowchart showing a flow of an operation of a drawing device constituting the image generating apparatus, FIG. 6 is a flowchart showing a flow of an operation of a drawing application processor, FIG. 7 is a sequence chart showing an operation of the image generating apparatus in this embodiment, and FIG. 8 is a view showing an example of a drawing.

At first, the basic configuration of the image generating apparatus in this embodiment is described with reference to FIG. 1.

In FIG.1, the image generating apparatus 1 is provided with a drawing application processor 11, a graphics library 12, a drawing device 13, a graphics memory 16 and a superimposing unit 17. Coordinate transformation input information 14 and drawing object input information 15 are inputted to the drawing application processor 11. The coordinate transformation input information 14 is used as souses of the coordinate transformation information. The coordinate transformation information includes information for defining a view point, a field of view, a light source and the like. The drawing object input information 15 is used as sources of the drawing object information. The drawing object information includes information of a road, a building, a map and the like. The graphics library 12 and the drawing device 13 constitute a system integrally with each other, and arbitrarily replaced for the drawing application processor 11.

The image generating apparatus 1 is designed so as to be able to generate images of the plurality of layers. Furthermore, the image generating apparatus 1 is designed so as to be able to generate a three-dimensional image(s) (i.e. a 3D image(s)). Thus, the image generating apparatus is designed so as to generate a multiple-layer 3D image. In order that the drawing device 13 generates a 3D image of the first layer, a first frame buffer 16a is installed within the graphics memory 16. In order to generate a 3D image of the second layer, a second frame buffer 16b is installed within the graphics memory 16. In order to generate 3D images of the other layers, the 3rd, 4th, 5th, . . . frame buffers are installed within the graphics memory 16. Namely, the frame buffers whose number is corresponding to the number of the layers are installed within the graphics memory 16. However, in FIG. 1, for the convenience of understanding, only the first frame buffer 16aand the second frame buffer 16b are illustrated. On the other hand, a Z-buffer 16c is installed within the graphics memory 16. Although the number of frame buffers corresponds to the number of the layers, the number of the Z-buffer 16c is one. The single Z-buffer 16c is used commonly to the 3D images of the plurality of layers. The Z-buffer 16c is used in a time sharing manner. For example, in order to generate the 3D image of the first layer, the frame buffer 16aand the Z-buffer 16c are used. In order to generate the 3D image of the second layer, the frame buffer 16b and the Z-buffer 16c are used. In this case, the use of the Z-buffer 16c for the 3D image of the first layer and the use of the Z-buffer 16c for the 3D image of the second layer are done at different times. Then, the 3D image of the first layer generated within the first frame buffer 16aand the 3D image of the second layer generated within the second frame buffer 16b are configured so as to be displayed on and outputted as one multiple-layer 3D image to a display unit, such as a liquid crystal display, a CRT display and the like, after they are superimposed by the superimposing unit 17.

In addition, in this embodiment, the single Z-buffer 16c is used to generate the 3D images of all the layers. However, the number of the Z-buffer is not limited to one. A plurality of Z-buffer may be installed. In this case, the graphics memory 16 is designed such that the number of the Z-buffers is less than that of the frame buffers or that of the layers. For example, the graphic memory 16 is designed such that two Z-buffers are used to generate the 3D images of three or more layers. By constituting in this manner, the capacity of the graphics memory 16 can be reduced while keeping performance of generating 3D images.

As shown in FIG.2, the drawing application processor 11 is composed of a coordinate transformation parameter generating routine 111 and a display list generating routine 112. The coordinate transformation parameter generating routine 111 generates the coordinate transformation information (a coordinate transformation parameters) containing the information of a view point, a field of view, a light source and the like on the basis of the coordinate transformation input information 14. The coordinate transformation parameter generating routine 111 generates the coordinate transformation information (the coordinate transformation parameters) for each of the 3D images of the plurality of layers. The coordinate transformation information (the coordinate transformation parameters) is managed as a scene object by the graphics library 12. Moreover, an identifier is set on the scene object. The operations for setting the coordinate transformation parameters for the scene object and applying the set coordinate transformation parameters to the drawing process are executed by identifying the identifier.

The display list generating routine 112 generates the drawing object information containing the information of a road, a building, a map and the like on the basis of the drawing object input information 15. Then, the display list generating routine 112 generates a display list by using the drawing object information. The display list generating routine 112 generates the drawing object information and the display list for each of the 3D images of the plurality of layers. Then, the display list generating routine 112 supplies the display list to the graphics library 12. The drawing object information does not include the coordinate transformation information or the coordinate transformation parameters. Also, the display list does not include the coordinate transformation information or the coordinate transformation parameters. The coordinate transformation information (the coordinate transformation parameters) is separately generated and set as the scene object. In this way, the drawing object information (the display list) and the coordinate transformation information (the coordinate transformation parameters) are separately and independently generated and managed for each of the 3D images of the plurality of layers, and the 3D image is generated by applying the coordinate transformation information to the drawing object information at the time of the execution of the image generating process. This attains the replacement of the system as mentioned above and the higher speed of the drawing speed.

Next, the graphics library 12 is composed of a scene object setting device 121, a display list arranging device 122 and a display list execution device 123.

The scene object setting device 121 stores the coordinate transformation information (the coordinate transformation parameters) generated by the coordinate transformation parameter generating routine 111 of the drawing application processor 11, and manages it. The coordinate transformation information (the coordinate transformation parameters) is stored in the scene object corresponding to the identifier set by the drawing application processor 11, for each of the 3D images of the plurality of layers.

The display list arranging device 122 arranges or reconstructs the display list generated by the display list generating routine 112 of the drawing application processor 11, for each of the 3D images of the plurality of layers. In the display list arranging device 122, the display list is arranged or reconstructed so as to be suitable for the drawing device 13. Thus, the drawing device 13 can directly execute the image generating process at a time by using the arranged or reconstructed display list. Therefore, the speed of the image generating process can be increased.

The display list execution device 123 controls the drawing device 13. When generating the 3D image, the display list execution device 123 instructs the scene object setting device 121 and the display list arranging device 122 to send the coordinate transformation information and the arrange or reconstructed display list to the drawing device 13, and further instructs the drawing device 13 to execute the image generating process. These operations are executed for each of the 3D images of the plurality of layers.

In this graphics library 12, for each of the 3D images of the plurality of layers, the coordinate transformation information (the coordinate transformation parameters) and the drawing object information (display list) are separated and stored. Then, at the time of the image generating process, the drawing device 13 applies the coordinate transformation information to the drawing object information, and carries out the coordinate transformation by adding the conditions of the view point, the field of view, the light source and the like, which are set as the scene object, and generates the 3D images of the respective layers. For each of the 3D images of the plurality of layers, the drawing object information included in a single display list is formed on a single coordinate system that does not depend on the view point and the field of view.

The 3D image of the first layer generated by the drawing device 13 is held by the corresponding first frame buffer 16a, and the hidden surface removal using the Z-buffer 16c is carried out. At this time, since the drawing device 13 applies the coordinate transformation to the drawing object information and generates the 3D image of the first layer, the drawing of the 3D image of the first layer is carried out like a burst processing manner. After the completion of the drawing of the 3D image of the first layer, the 3D image of the second layer generated by the drawing device 13 is held by the corresponding second frame buffer 16b, and the hidden surface removal using the Z-buffer 16c is carried out. At this time, the drawing of the 3D image of the second layer is also done like the burst processing manner. After the completion of the drawing of the 3D image of the second layer, the 3D images of the two layers stored in the first frame buffer 16aand the second frame buffer 16b are superimposed by the superimposing unit 17, and thereby made into the multiple-layer 3D image, and inputted to and displayed on a display unit 19. In particular, since the generating of the 3D images of the respective layers are done like the burst processing manner, the Z-buffer 16c can be used in the time sharing, as mentioned above. Thus, the 3D images of three or more layers can be sufficiently superimposed while the hidden surface removals are carried out by using one Z-buffer 16c.

The procedure for generating the 3D images of the respective layers will be described below with reference to FIG.3. At first, the drawing application processor 11 generates a display list for a 3D image of the first layer (Procedure (1)). The generated display list is stored as an object display list (1) of the graphics library 12. Next, the drawing application processor 11 generates coordinate transformation information (coordinate transformation parameters) for this 3D image (Procedure (2)). The coordinate transformation information (the coordinate transformation parameters) is stored in a scene object (1). At this time, an identifier is set on the scene object (1). Next, the drawing application processor 11 instructs the graphics library 12 to execute the image generating process (Procedure (3)). In response to this, the graphics library 12 accesses the display list (1) and the scene object (1), sends the drawing object information of the display list (1) and the coordinate transformation information of the scene object (1) to the drawing device 13, and instructs the drawing device 13 to execute the image generating process. In response to this, the drawing device 13 executes the image generating process, thereby generating the 3D image of the first layer. At this time, the hidden surface removal is executed by using the Z-buffer 16c, and the 3D image of the first layer is held in the frame buffer 16a. After that, the similar image generating procedures are performed on a 3D image of the second layer. Moreover, if there is a 3D image of the third or additional layer, the similar image generating procedures are performed thereon.

The drawing device 13 has the coordinate transformation function. On the basis of the coordinate transformation parameters indicated by the identifier, for example, on the basis of a view point and a field of view of a driver, a light source, and the like if a car is driving, a drawing object information, for example, a current view during the driving that is watched by the driver is generated and displayed in the 3D image. At this time, many object display lists or scene objects can be generated and stored in advance, and any one of or some display lists and any one of or some scene objects can be combined.

The flow of the operation of the graphics library 12 will be described below with reference to FIG.4.

At first, from a waiting state for an operation input from the drawing application processor 11 (Step S101), if there is the operation input, a type of the operation is checked (Step S102). The types of the operation in the graphics library 12 are the arranging or reconstructing of the display list, the setting of the scene object, the clear of the Z-buffer and the execution of the display list.

If the arranging or reconstructing of the display list is indicated, the display list received from the drawing application processor 11 is arranged or reconstructed so as to be suitable for the drawing device 13 (Step S103). After the arranging or reconstructing of the display list, the operational flow returns back to the step S101, and waits for a next operation input.

As the checked result at the step S102, if the operation input is the setting of the scene object, the coordinate transformation information received from the drawing application processor 11 is set to the scene object indicated by the identifier (Step S104). When the setting of the scene object is completed, the operational flow again returns back to the step S101 and waits for a next operation input.

As the checked result at the step S102, if the operation input is the execution of the display list, the scene object indicated by the identifier is set for the drawing device 13 (Step S105). Then, the graphics library 12 instructs the drawing device 13 to execute the display list (i.e. to execute the image generating process) (Step S106).

As the checked result at the step S102, if the operation input is the clear of the Z-buffer 16c, the Z-buffer 16c in the graphics memory 16 is cleared (Step S111). The operation input representative of the clearing of this Z-buffer is done when the image generating process related to the 3D image of the first layer is completed after the execution of the step S106.

After that, the operational flow returns back to the step S101 and waits for a next operation input. The drawing device 13 executes the display lists at a time, and generates the image. The executing procedure is based on the executing procedures described with reference to FIG. 3.

The flow of the operation of the drawing device 13 will be described below with reference to FIG. 5.

At first, from a waiting state for an operation input from the graphics library 12 (Step S201), if there is the operation input, a type of the operation is checked (Step S202). As the types of the operation, there are the setting of the scene object and the execution of the display list.

If the setting of the scene object is indicated, the drawing device 13 sets the coordinate transformation parameters corresponding to the scene object indicated by the identifier (Step S203). After the completion of the setting of the coordinate transformation parameters, the operational flow again returns back to the step S201 and waits for a next operation input.

As the checked result at the step S202, if the operation input is the execution of the display list, the image generating process is executed on the basis of the coordinate transformation parameters and the display list. The generated image is outputted from the drawing device 13, and stored in the corresponding frame buffer 16aor 16b. At this time, the hidden surface removal is carried out by using the Z-buffer 16c.

Then, by repeating the above-mentioned operations, the 3D images of the plurality of layers are generated within the first frame buffer 16aand the second frame buffer 16b, respectively. Finally, they are superimposed by the superimposing unit 17, and made into the single multiple-layer 3D image.

The flow of the operation in the drawing application processor 11 will be described below with reference to FIG.6.

At first, the respective display lists of the 3D image of the first layer and the 3D image of the second layer are generated by the display list generating routine 112. Then, the corresponding coordinate transformation parameters are generated by the coordinate transformation parameter generating routine 111 (Step S501).

When generating of the display list and the coordinate transformation parameters required to generate one multiple-layer 3D image are ended, an instruction to clear the Z-buffer 16c is sent to the graphics library 12. In response to this, the graphics library 12 clears the Z-buffer 16c (Step S502).

Next, an instruction to generate the 3D image of the first layer by applying the coordinate transformation parameters to the display list is sent to the graphics library 12. At this time, the display list related to the 3D image of the first layer is selected from among the display lists generated at the step S501, and the corresponding coordinate transformation parameters generated at the step S501 are selected. In response to the instruction from the drawing application processor 11, the graphics library 12 controls the drawing device 13 to generate the 3D image of the first layer. Then, the hidden surface removal is carried out by using the Z-buffer 16c cleared at the step S502 (Step S503). For example, the hidden surface removal is performed in the following manner. The 3D image of one frame is composed of several or many partial frame images, such as an image of a road, an image of one building, an image of a different building, an image of a sky and the like. On the other hand, a drawing space is divided into small drawing portions for the convenience of the processing. In each drawing portion, the partial frame images located within one drawing portion are compared to each other, and the image portion located closest to the viewer is extracted and stored. Finally, the 3D image of the one frame is generated by combining the stored image portions in all the drawing portions.

After the completion of the generating of the 3D image of the first layer constituted by the execution of the hidden surface removal through the Z-buffer, an instruction to clear the Z-buffer 16c is sent to the graphics library 12 again. In response to this, the graphics library 12 clears the Z-buffer 16c (Step S504).

Next, an instruction to generate the 3D image of the second layer by applying the coordinate transformation parameters to the display list is sent to the graphics library 12. At this time, the display list related to the 3D image of the second layer is selected from among the display lists generated at the step S501, and the corresponding coordinate transformation parameters generated at the step S501 are selected. In response to the instruction, the graphics library 12 controls the drawing device 13 to generate the 3D image of the second layer. Then, the hidden surface removal is carried out by using the Z-buffer 16c cleared at the step S504 (Step S505).

As mentioned above, the 3D images of the respective layers are generated within the first and second frame buffers 16a, 16b, respectively. Finally, they are superimposed by the superimposing unit 17 and made into the single multiple-layer 3D image. In this way, one Z-buffer 16c is used in the time sharing when the 3D images of the respective layers are generated. Thus, the single Z-buffer 16c is commonly used to generate 3D images of the plurality of layers.

The operation of the image generating apparatus will be described below along the temporal flow with reference to a sequence chart of FIG.7. This sequence chart temporally shows the mutual relation between the drawing application processor 11, the graphics library 12, the drawing device 13 and the graphics memory 16. The lateral line represents the mutual relation, and the longitudinal line represents the temporal elapse from the top to the bottom.

At first, the drawing application processor 11 generates a display list (1) related to the 3D image of the first layer, and sends it to the graphics library 12 (Step S601). Before and after this operation, the drawing application processor 11 generates coordinate transformation parameters and sets an identifier. Then, the drawing application processor 11 instructs the graphics library 12 to set the coordinate transformation parameters to a scene object corresponding to the identifier.

Next, the drawing application processor 11 generates a display list (2) related to the 3D image of the second layer, and sends it to the graphics library 12 (Step S602). Before and after this operation, the drawing application processor 11 generates coordinate transformation parameters and sets an identifier. Then, the drawing application processor 11 instructs the graphics library 12 to set the coordinate transformation parameters to a scene object corresponding to the identifier.

Next, the drawing application processor 11 instructs the graphics library 12 to clear the Z-buffer 16c. In response to this, the graphics library clears the Z-buffer (Step S603).

After that, the drawing application processor 11 instructs the graphics library 12 to generate the 3D image of the first layer by applying the coordinate transformation information to the display list (1) (Step S604).

In response to this instruction, the graphics library 12 supplies the display list (1) related to the 3D image of the first layer together with the corresponding scene object (the corresponding coordinate transformation information) to the drawing device 13, and instructs the drawing device 13 to execute the display list (1) (Step S606).

The drawing device 13, when receiving this instruction, executes the image generating process on the display list (1). More concretely, the drawing device 13 applies the corresponding coordinate transformation information to the display list (1), and the hidden surface removal by using the Z-buffer 16c. Thus, the 3D image of the first layer is generated in the first frame buffer 16a(Step S607). When the image generating process in the first frame buffer 16ais ended, the drawing device 13 reports the completion of the image generating process for the first layer to the graphics library 12 and the drawing application processor 11 (Step S608).

In response to this, the drawing application processor 11 instructs the graphics library 12 to clear the Z-buffer 16c again. In response to this, the graphics library clears the Z-buffer 16c (Step S609).

After that, the drawing application processor 11 instructs the graphics library 12 to generate the 3D image of the second layer by applying the coordinate transformation information to the display list (2) (Step S610).

In response to this instruction, the graphics library 12 supplies the display list (2) related to the 3D image of the second layer together with the corresponding scene object (the corresponding coordinate transformation information) to the drawing device 13, and instructs the drawing device 13 to execute the display list (2) (Step S611).

The drawing device 13, when receiving this instruction, executes the image generating process on the display list (2). More concretely, the drawing device 13 applies the corresponding coordinate transformation information to the display list (2), and executes the hidden surface removal by using the Z-buffer 16c. Thus, the 3D image of the second layer is generated in the second frame buffer 16b (Step S612). When the image generating process in the second frame buffer 16b is ended, the drawing device 13 reports the completion of the image generating process for the second layer to the graphics library 12 and the drawing application processor 11 (Step S613), and executes the process for ending the image generating process. Moreover, at this time, the superimposing unit 17 superimposes the 3D image of the first layer stored in the first frame buffer 16aand the 3D image of the second layer stored in the second frame buffer 16b, and outputs the superimposed images as the multiple-layer 3D image to the display unit 19. Thus, the multiple-layer 3D image is displayed.

Incidentally, after the generating of the current multiple-layer 3D image is ended, the drawing application processor 11 may check whether or not the multiple-layer 3D image of the next field of view (the next frame) can be generated by using the current display list (1) or (2). If the multiple-layer 3D image of the next field of view (the next frame) can be generated by using the current display list (1) or (2), generating of the display list for the next field of view (the next frame) can be omitted because the display list (1) or (2) can be used again.

As mentioned above, in FIG.7, at a period T1, the Z-buffer 16c is used to generate the 3D image of the first layer, and at a period T2, the same Z-buffer 16c is used to generate the 3D image of the second layer. Thus, the single Z-buffer 16c is used in the time sharing manner to generate both of the 3D image of the first layer and the 3D layer image of the second layer.

FIG.8 is an example of the displaying of the multiple-layer 3D images generated as mentioned above. FIG.8 shows the main image and two sub images 28, 29 which are located on the map image in an overlapping state. The main image shows a view on the basis of the view point of a driver when a car is driving on a road in a town. In FIG.8, a light source 21, a view point 22, a field of view 23 and the like relate to the coordinate transformation information represented by the identifier set in the scene object. Buildings 24a, 24b, 24c, . . . and a road 25 and the like correspond to the drawing object information. For example, the light source 21 is the sun in the daytime, and it is a streetlight in the night. Their positions and the illumination directions are the parameters. Also, is the view point is set on the basis of the view point of a driver, the driver can be watched at the feeling similar to that of the view of the environment in which the car is driving. The field of view 23 defines a predetermined image range. This range is set so as to be suitable for the driver.

Also, the buildings 24a, 24b, 24c, . . . and the road 25 and the like correspond to the drawing object information. The display list in relation to them is generated in the format that can be directly executed by the drawing device. The drawing object information can be used from those supplied through a map information database of the navigation system and the like. Also, the format as the drawing object information is represented in the single coordinate system that does not contain the coordinate transformation information.

In FIG.8, in accordance with the information of the scene object, the light source 21, namely, the sun is forwardly located, and therefore, the side of the buildings 24a, 24b, 24c, . . . that faces the driver is darkly shaded. Also, the view point 22 is located over the road 25. Then, the coordinate transformation is done such that the drawing objects, such as the buildings 24a, 24b, 24c, . . . and the road 25 and the like which are within the range set by the field of view 23, are converged to this view point 22, by using the method based on the perspective.

In this embodiment, in particular, the main image is the first 3D image after the hidden surface removal is executed by using the Z-buffer as mentioned above. The sub image 28 that is the second 3D image is displayed on the upper right portion of the main image in FIG.8. The sub image 28 shows a situation of a tollgate is drawn in the 3D image. The sub image 28 is also the 3D image generated by executing the hidden surface removal using the Z-buffer 16c as mentioned above.

By the way, in FIG. 8, the sub image 29 for illustrating character information is displayed on the lower right portion of the main image. Even this sub image 29 may be displayed as a 3D image (for example, a cubic character) generated by executing the hidden surface removal using the Z-buffer 16c.

As mentioned above, since one Z-buffer 16c is used in the time sharing, the multiple-layer 3D image can be displayed while the increase in the necessary memory capacitance is suppressed. For example, the image generating apparatus in this embodiment is suitable for the field in which the suppression of the capacity for the graphics memory, such as a car navigation system and the like, is important. Moreover, since the drawing object information and the coordinate transformation information are separated and treated, the coordinate transformation can be performed at a high speed, and therefore, the image can be generated at high speed. Also, by changing the coordinate transformation information while the drawing object information is fixed, the same drawing object can be easily generated at a different coordinate. The separation between the drawing object information and the coordinate transformation information enables the drawing device to be select or replaced.

Second Embodiment

The above-mentioned image generating apparatus will be described below by exemplifying the case when this apparatus is applied to a navigation system for a mobile body. The various functions of the navigation system are closely related to the image generating apparatus. Therefore, the image generating apparatus are installed in the navigation system integrally. This point is described in detail. Incidentally, the configuration and the operations of the image generating apparatus itself are similar to those as mentioned above. Then, the re-explanation is omitted. The above-mentioned explanation is suitably seen as necessary.

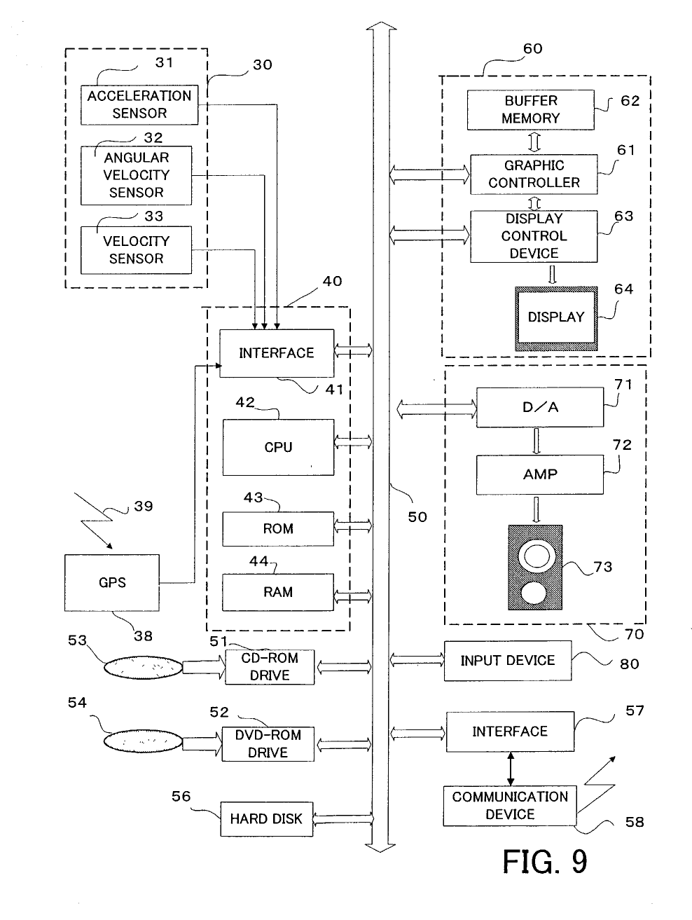

At first, the navigation system of this embodiment is schematically described with reference to FIG.9.

The navigation system is provided with a self-contained positioning apparatus 30, a GPS receiver 38, a system controller 40, an input/output (I/O) interface circuit 41, a CD-ROM drive 51, a DVD-ROM drive 52, a hard disk device (HDD) 56, a wireless communication device 58, a display unit 60, an audio output unit 70, an input device 80 and an external interface (I/F) device (not shown). The respective devices are connected to a bus line 50 for a control data transfer and a process data transfer.

The self-contained positioning apparatus 30 is constructed to include an acceleration sensor 31, an angular velocity sensor 32, and a velocity sensor 33. The acceleration sensor 31, which is constructed by a piezoelectric element, for example, detects an acceleration of a vehicle and outputs acceleration data. The angular velocity sensor 32, which is constructed by a vibration gyro, for example, detects an angular velocity of a vehicle when the vehicle changes its moving direction and outputs angular velocity data and relative azimuth data. The velocity sensor 33 detects a rotation of a vehicle shaft, mechanically, magnetically or optically, and outputs a signal of a pulse number corresponding to a car speed at every rotation for a predetermined angle around the vehicle shaft.

The GPS receiver 38 has the known configuration in which it has a plane polarization non-directional reception antenna, a high frequency reception processor, a digital signal processor (DSP) or a micro processor unit (MPU), a V-RAM, a memory and the like. The GPS receiver 38 receives the electric waves from at least three GPS satellites placed into orbit around the earth, and carries out a spectral back-diffusion, a distance measurement, a Doppler measurement, an orbit data process, and carries out a position calculation and a movement speed azimuth calculation, and continuously outputs an absolute position information of a reception point (a car driving point) from the I/O circuit 41 to the bus line 50, and the system controller 40 captures it, and carries out a screen display on a map road.

The system controller 40 is composed of a CPU (Central Processing Unit) 42, a ROM (Read Only Memory) 43 that is a non-volatile solid memory device, and a working RAM 44, and it sends and receives a data to and from the respective units connected to the bus line 50. The process control for sending and receiving this data is executed by a boot program and a control program stored in the ROM 43. In particular, the RAM 44 transiently stores the setting information to change a map display (change to an entire or district map display) through a user operation from the input device 80 and the like.

The CD-ROM drive 51 and the DVD-ROM drive 52 read out, from a CD-ROM 53 and a DVD-ROM 54, the map database information (for example, the various road data such as the number of lanes, a road width and the like in the map information (drawings) respectively stored therein, and output them.

The hard disk device 56 can store the map (image) data read by the CD-ROM drive 51 or the DVD-ROM drive 52 and then read out it at any time after it is stored. The hard disk device 56 can further store a voice data and an image data read from the CD-ROM drive 51 or the DVD-ROM drive 52. Consequently, for example, it is possible to read out the map data on the CD-ROM 53 and the DVD-ROM 54, and carry out the navigation operation, and meanwhile read out the voice data and the image data stored in the hard disk device 56 and then carry out a voice output and an image output. Or, it is possible to read out the voice data and the image data on the CD-ROM 53 and the DVD-ROM 54, and carry out the voice output and the image output, and meanwhile read out the map data stored in the hard disk device 56 and then carry out the navigation operation.

The display unit 60 displays the various process data on the screen under the control of the system controller 40. The display unit 60 controls the respective portions of the display unit 60 in accordance with the control data transferred from the CPU 42 through the bus line 50. Also, it transiently stores an image information that can be instantly displayed by a buffer memory 62 using V-RAM. Moreover, a display controller 63 carries out a display control, and displays an image data outputted from a graphic controller 61 on a display 64. This display 64 is placed near a front panel in the car.

In the audio output unit 70, a D/A converter 71 converts the voice signal transferred through the bus line 50 under the control of the system controller 40, into a digital signal. At the same time, a voice analog signal outputted from the D/A converter 71 is variably amplified by a variable amplifier (AMP) 72, outputted to a speaker 73, and outputted as a voice from it.

The input device 80 is composed of keys, switches, buttons, a remote controller, a voice input unit and the like to enter the various commands and the data. The input device 80 is placed around the display 64 and a front panel of a main body of the car electronic system installed in the car.

Here, in the navigation system, it is required to suitably display the image coincident with a drive route. That is, the image watched from the driver's view point on the road on which the driver is currently driving is desired to be displayed in the 3D image. Also, from the viewpoint of safety, it is useful to display, in the 3D image, the image when the car turns at a forward crossing and the view ahead of an unclear location, and also report its fact to the driver. Moreover, various messages need to be superimposed on the image and displayed. Such requirements of the navigation system are also the requirements of the image generating apparatus installed in the navigation system, and the image generating apparatus can satisfy these requirements, as mentioned above.

Thus, by installing the above-mentioned image generating apparatus in the navigation system and designating the navigation system so as to cooperate the image generating apparatus with the various devices of the navigation system, the extremely effective navigation system can be attained.

The cooperating operation of the image generating apparatus and the various devices of the navigation system will be described below.

As mentioned above, in the image generating apparatus, the drawing application processor 11 separately generates the coordinate transformation information of the view point, the field of view, the light source and the like and the drawing object information of the road, the building and the like. Then, the graphics library 12 separately stores and manages these two kinds of information. Then, the drawing device 13 actually generates the images by using these information.

As the drawing object information, the map information containing information of a road and a building is used. The map information is obtained from the map database of the navigation system. More concretely, the map information is stored in the CD-ROM 53 and the DVD-ROM 54 and read out through the CD-ROM drive 51 and the DVD-ROM drive 52. Also, the map information can be obtained through the communicating unit 58 from a predetermined site and stored in the hard disk device 56 to thereby use it. Also, after the map information of the drive route read out through the CD-ROM drive 51 or the DVD-ROM drive 52 is stored, it can be read out at any time. This work may be carried out when a drive plan is prepared.

The map information is divided into many regions. The divided map information included in the respective regions are represented by the various coordinate systems. Namely, in respective regions, the coordinate systems are not the same. The display list generating routine 112 of the drawing application processor 11 in the image generating apparatus converts the map information into drawing object information of a single coordinate system, which does not depend on the position of a view point and a field of view, and generates a display list on the basis of the drawing object information. Then, the drawing application processor 11 instructs the graphics library 12. In response to this instruction, the display list arranging device 122 of the graphics library 12 arranges or reconstructs the display list so as to be suitable for the drawing device 13. Then, the display list arranging device 122 stores and manages the arranged or reconstructed display list.

On the other hand, information of the view point, the field of view, the light source and the like which are used as the sources of the coordinate transformation information can be obtained in the following manner. Namely, in order to determine the view point, the field of view, the light source and the like, at first, it is necessary to know a current position of the car during the driving. This current position is measured by the GPS receiver 38 or the self-contained positioning apparatus 30 of the navigation system. Then, the location on the map information corresponding to the measured current position is determined by comparing the map information with the measured current position. Thus, the traveling direction of the car and the proper view point and field of view are determined. Incidentally, the view point and the field of view may be determined at a predetermined position or range. Moreover, these point and field may be set manually.

If the traveling direction of the car and the current time are known, the direction of the sun can be determined by considering the seasonal factor. On the basis of this, the location of the light source is determined. Also, if a view of an arrival location after a predetermined time is desired to be watched, the direction of the sun can be determined by similarly setting the position and the arrival time. Thus, it is possible to watch the image in which the effect of the position of the light source at the arrival time is reflected.

Also, the change in the shade and shadow of a view from a sunrise to a sundown can be displayed by applying the coordinate transformation information concerning the light source to the drawing object information while changing the coordinate transformation information according to the momentarily changing time. Moreover, the change of the location or the form of the 3D image can be sequentially displayed by sequentially changing the coordinate transformation information of the view point, the field of view or the like. In particular, if the change of 3D image corresponding to the change of the view when the car is continuously driving on the same road is displayed, the coordinate transformation information is changed in association with the driving while the drawing object information is fixed. Thus, the continuous change of the 3D image can be displayed efficiently.

As mentioned above, the function of the navigation system can be used to determine the scene object serving as the coordinate transformation information, and the map information can be used to determine the drawing object information. Thus, the 3D image can be generated on the basis of the coordinate transformation information and the drawing object information independently of each other. The image is introduced into the display unit 60 of the navigation system, and accumulated in the buffer memory 62 using the V-RAM and the like by the graphic controller 61, and read out from it, and then displayed on the display 64 through the display controller 63.

As mentioned above, the image generating apparatus of the present invention has been described by exemplifying the case of the application to the navigation system. However, it is not limited to this case. Preferably, it may be used for the image generation in a personal computer, a work station, a mobile, a portable telephone and the like, the image generation in a television game, an arcade game, a portable game and the like, and the image generation in a handling simulation apparatus or a training apparatus for various mobile bodies such as a car, a motorcycle, an airplane, a helicopter, a rocket, a ship and the like.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-295167 filed on Sept. 26, 2001 including the specification, claims, drawings and summary is incorporated herein by reference in its entirety.

What is claimed is:

1. An image generating apparatus comprising:
an image generating device for generating images of a plurality of layers containing a three-dimensional image;
an image storing device comprising a plurality of frame buffers for separately storing the generated images of the plurality of layers and one Z-buffer;
a processing device for carrying out an image processing including a hidden surface removal on the generated images of the plurality of layers by using the Z-buffer in a time sharing manner; and
a superimposing device for superimposing the images on which the image processing is carried out by the processing device.

2. An image generating apparatus according to claim 1 further comprising:
a clearing device for clearing the Z-buffer whenever completing the image processing of each one of the images of the plurality of layers.

3. An image generating apparatus according to claim 1, wherein the images of the plurality of layers contain a three-dimensional image which is to be drawn in perspective.

4. An image generating apparatus according to claim 1, further comprising:
a drawing object information generating device for generating drawing object information, which is information for drawing objects as the three-dimensional image, in a single coordinate system;
a coordinate transformation information generating device for generating coordinate transformation information, which is information for defining at least one of a view point and a field of view concerning the three-dimensional image;
a drawing object information storing device for storing the drawing object information; and
a coordinate transformation information storing device for storing the coordinate transformation information,
wherein the image generating device generates the three-dimensional image by using the stored drawing object information and the stored coordinate transformation information.

5. An image generating apparatus according to claim 4, wherein the coordinate transformation information generating device generates a plurality of units of the coordinate transformation information, in which at least one of the view point and the field of view is different from each other, with respect to one unit of the drawing object information, and the image processing device generates the three-dimensional image which changes with time by applying the plurality of units of the coordinate transformation information to the one unit of the drawing object information.

6. An image generating apparatus according to claim 4, wherein a process of generating the drawing object information in the drawing object information generating device, a process of generating the coordinate transformation information in the coordinate transformation information generating device, a process of storing the drawing object information in the drawing object information storing device and a process of storing the coordinate transformation information in the coordinate transformation information storing device are carried out with multitasking.

7. An image generating apparatus according to claim 4, wherein the drawing object information storing device stores a plurality of units of the drawing object information generated by the drawing object information generating device, the coordinate transformation information storing device stores a plurality of units of the coordinate transformation information generated by the coordinate transformation information generating device, and the image generating device generates the three-dimensional image with an arbitrary combination of one or more than one of the plurality of units of the drawing object information and one or more than one of the plurality of units of the coordinate transformation information.

8. An image generating apparatus according to claim 4, wherein the drawing object information generating device comprises a list generating device for generating a list of the drawing object information.

9. An image generating apparatus according to claim 4, wherein the image generating apparatus includes a drawing application processor and a graphics library,
the graphics library comprises:
the drawing object information storing device;
the coordinate transformation information storing device;
a first controlling device for controlling the image storing device; and
a second controlling device for controlling the image generating device and the processing device, and
the drawing application processor comprises:
the drawing object information generating device;
the coordinate transformation information generating device;
a first instructing device for instructing the first controlling device to clear the Z-buffer; and
a second instructing device for instructing the second controlling device to execute the generation of the three-dimensional image, a generation of other images of the plurality of layers and the image processing.

10. An image generating apparatus according to claim 4, further comprising:
a map information supplying device for supplying map information, which contains a source of the drawing object information, to the drawing object information generating device.

11. An image generating apparatus according to claim 4, wherein the coordinate transformation information includes information for defining a light source.

12. An image generating apparatus according to claim 4, wherein the information for defining the view point is set on the basis of a view point of a movable body operator.

13. An image generating apparatus according to claim 4, wherein the information for defining the field of view is set on the basis of a field of view of a movable body operator.

14. An image generating apparatus according to claim 1 further comprising:
a display device for displaying the images superimposed by the superimposing device.

15. A program storage device readable by a computer for tangibly embodying a program of instructions executable by the computer to perform an image generating method, the image generating method comprising:
an image generating process of generating images of a plurality of layers containing a three-dimensional image;
a hidden surface removal process of carrying out an image processing including a hidden surface removal on the generated images of the plurality of layers by using one Z-buffer in a time sharing manner; and
a superimposing device for superimposing the images on which the image processing is carried out.

16. A computer data signal embodied in a carrier wave and representing a series of instructions which cause a computer to perform an image generating method, the image generating method comprising:
an image generating process of generating images of a plurality of layers containing a three-dimensional image;
a hidden surface removal process of carrying out an image processing including a hidden surface removal on the generated images of the plurality of layers by using one Z-buffer in a time sharing manner; and
a superimposing device for superimposing the images on which the image processing is carried out.

17. An image generating method comprising:
an image generating process of generating images of a plurality of layers containing a three-dimensional image;
a hidden surface removal process of carrying out an image processing including a hidden surface removal on the generated images of the plurality of layers by using one Z-buffer in a time sharing manner; and
a superimposing device for superimposing the images on which the image processing is carried out.

18. An image generating method according to claim 17, wherein the Z-buffer is cleared whenever completing the image processing of each one of the images of the plurality of layers.

19. An image generating method according to claim 17 further comprising:
a drawing object information generating process of generating drawing object information, which is information for drawing objects as the three-dimensional image, in a single coordinate system;
a coordinate transformation information generating process of generating coordinate transformation information, which is information for defining at least one of a view point and a field of view concerning the three-dimensional image;
a drawing object information storing process of storing the drawing object information; and
a coordinate transformation information storing process of storing the coordinate transformation information,
wherein, in the image generating process, the three-dimensional image is generated by using the stored drawing object information and the stored coordinate transformation information.
